(19) United States
(12) Patent Application Publication
(10) Pub. No.: US 2006/0055790 A1
(43) Pub. Date: Mar. 16, 2006

(54) Video camera remote fine-tuning installation

(75) Inventors: I-Chang Chen, Dasi Township (TW); Chung-Yun Peng, Dasi Township (TW); Chih-Wei Cheng, Dasi Township (TW)

Correspondence Address: TROXELL LAW OFFICE PLLC;SUITE 1404, 5205 LEESBURG PIKE, FALLS CHURCH, VA, 22041, US

(73) Assignee: Longtek Electronics Co., Ltd.

(21) Appl. No.: 10/940,617

(22) Filed: Sep. 15, 2004

(51) Int. Cl. H04N 5/232

(52) U.S. Cl. 348/211.2

(57) ABSTRACT

A hand-held information equipment provided with dynamic image display and wireless network transmission function s includes a built-in process software to set up/judge command codes of operation keys; being on line with multiple video cameras through a control unit to display pictures transmitted from the camera; and sends signals for real time control of the camera to rotate, adjust elevation and focus in shooting.

### BACKGROUND OF THE INVENTION

(a) Field of the Invention

The present invention is related to an installation for achieving the wireless network transmission control of a remote video camera to search picture, and more particularly, to one of a hand-held for its user to monitor real dynamic pictures received at where the video camera is located.

(b) Description of the Prior Art

As the network transmission rate increases rapidly and the popular of mobile wireless network service, cellular phone or PDA user while browsing information on the web pages is now able to communicate with another user while viewing the dynamic images of each other. Certain household security systems transmit the images from the monitor, i.e., a video camera, installed at the home to the cellular phone, or similar hand-held information equipment provided with wireless network transmission function of the home owner working in the office or traveling on the road to have real time monitor of his home.

The video camera for monitoring purpose is usually installed at a fixed location with a dead or limited shooting angle. Certain video camera operates on a rotation bracket to move back and forth within a specified area. However, the searching mode of the video camera of the prior art is passive since it moves reciprocally at a given speed, and the switch of pictures of each video camera is done at a given sequence and a given time. Therefore, the video camera of the prior art fails to have active search or follow up any emergency.

An improvement taught by ROC Patent Publication No. 511741 for an installation of using computer keyboard and mouse to fin tune focus of an approximate/remote video camera however fails to achieve the purpose of follow-up/search the target for shooting by the video camera due to that it does not allow the direct control by a hand-held information equipment, or the remote control for the video camera to rotate or adjust its elevation.

### SUMMARY OF THE INVENTION

The primary purpose of the present invention is to provide an installation for fine tuning the operation of a remote video camera using a hand-held information equipment for the user of the hand-held commands the active control the video camera to take optimal dynamic pictures to effectively upgrade the real time monitoring purpose at the same time for both of the hand-held and the video camera. To achieve the purpose, the hand-held equipment is adapted with a built-in process software to set up/judge command codes of its operational keys and is on-line with one or multiple video camera through a control unit to display the pictures transmitted from the camera. Meanwhile the hand-held equipment controls the shooting of the video camera by sending signals to the video camera to rotate, adjust its elevation and/or focus as applicable.

### BRIEF DESCRIPTION OF THE DRAWINGS

FIG. 1 is a schematic view showing a basic configuration of a first preferred embodiment of the present invention.

FIG. 2 is a flow chart showing the operation of the first preferred embodiment of the present invention.

FIG. 3 is a schematic view showing that a video camera of the first preferred embodiment of the present invention is in its rotating status

FIG. 4 is a schematic view showing that the video camera of the first preferred embodiment of the present invention is adjusting its elevation.

FIG. 5 is a schematic view showing that a video camera of the first preferred embodiment of the present invention is adjusting its focus.

FIG. 6 is a schematic view showing a basic configuration of a second preferred embodiment of the present invention.

### DETAILED DESCRIPTION OF THE PREFERRED EMBODIMENTS

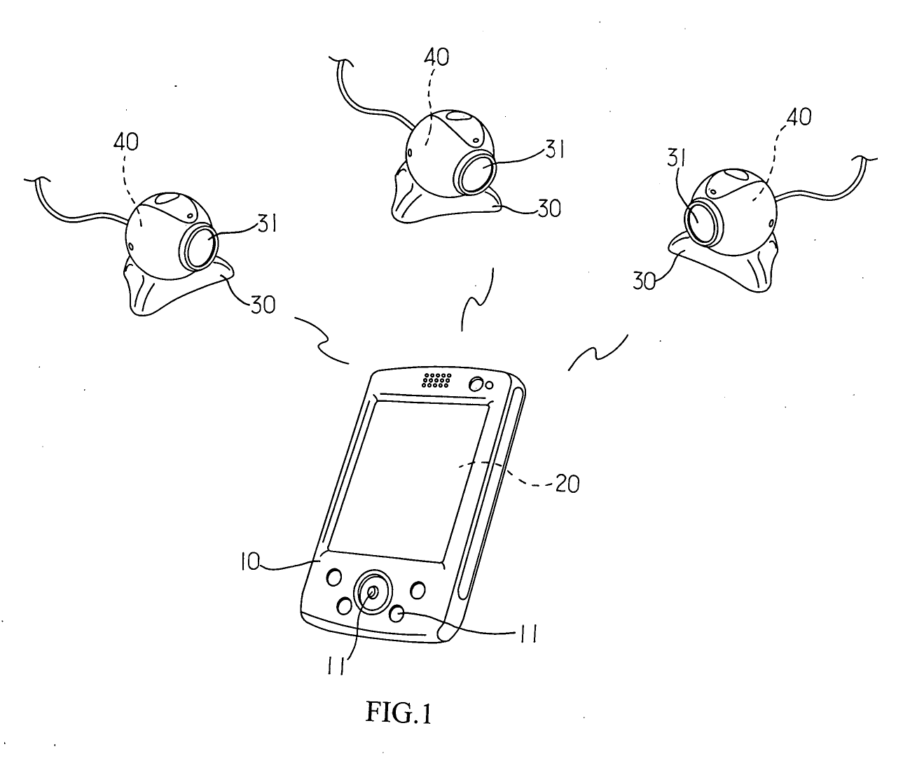

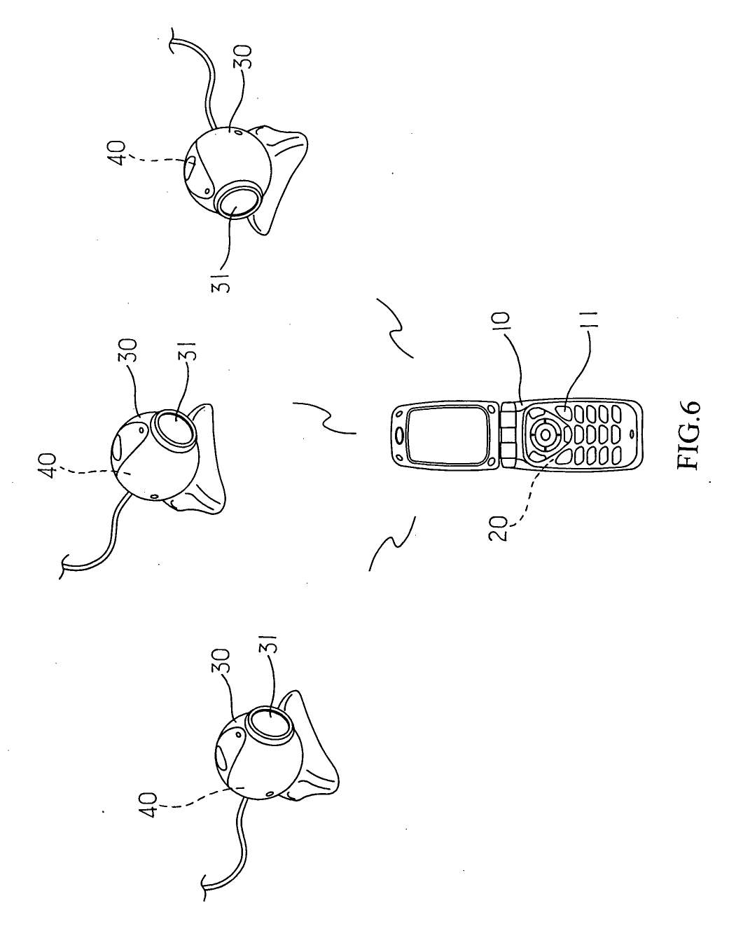

The present invention related to an installation for fine tuning operation of a remote video camera by a hand-held information equipment essentially operates on wireless network transmission of the hand-held information equipment provided with functions of wireless network transmission and display of dynamic images to receive real time images from a remote (or approximate) video camera while controlling the video camera to rotate, adjust its elevation and/or focus as applicable for the hand-held information equipment user to actively search for optimal pictures in paying the real time monitor results by the hand-held information equipment and the video camera. The installation is essentially comprised of a hand-held information equipment 10 provided with functions of dynamic images display and wireless network transmission in a form of a PDA as illustrated in FIG. 1 or a cellular phone as illustrated in FIG. 6, or in any other form of similar functions; a process software 20 built in the hand-held information equipment 10 to set up/judge command codes of operational keys, pictures transmitted from a video camera 30, and the switch of the video camera subject to its control; and one or multiple video camera 30 provided with a control unit 40 connected to the network for transmitting the pictures to the hand-held information equipment 10 for display and to receive signals sent from the hand-held information equipment 10.

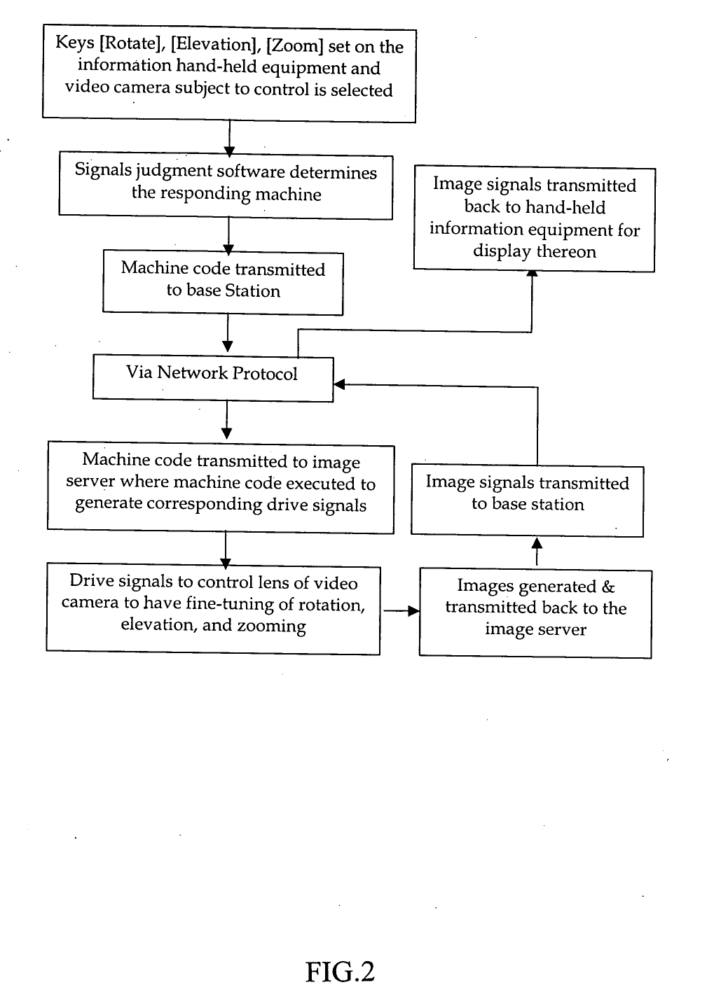

Accordingly, as illustrated in FIGS. 1 and 2, an operation key 11 to control rotation, elevation and focusing of the video camera 30 from the hand-held information equipment 10 is set up and the video camera 30 subject to the control is selected. The process software 20 judges and produces the corresponding command code, then transmits the command code to a base station to facilitate the network protocol to transmit the command code to the control unit 40, i.e., an image server, of the camera 30; meanwhile the images taken by the video camera 30 are synchronously transmitted to the base station where sends the signals in real time for the hand-held information equipment 10 to pick up the pictures taken by the video camera 30.

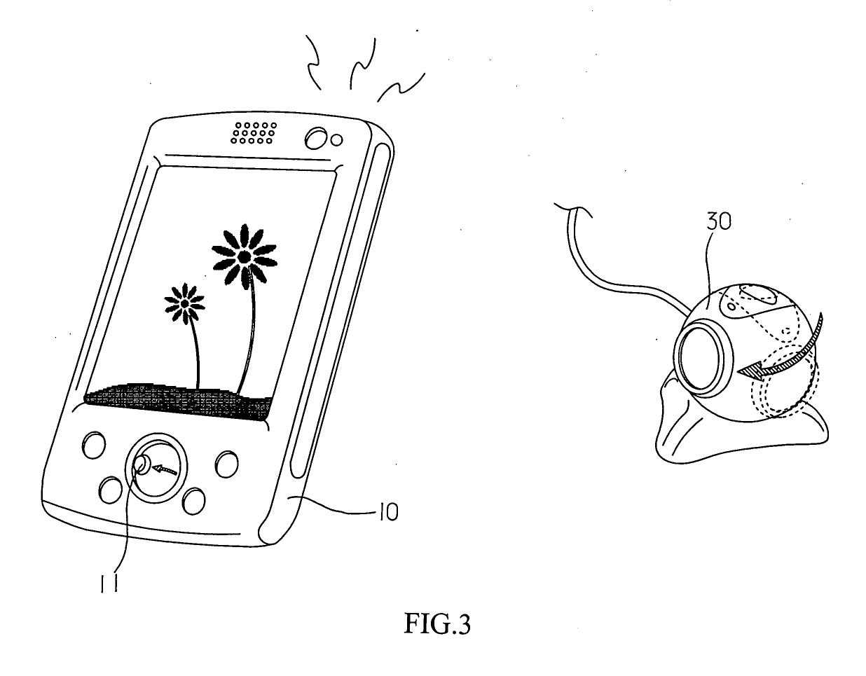

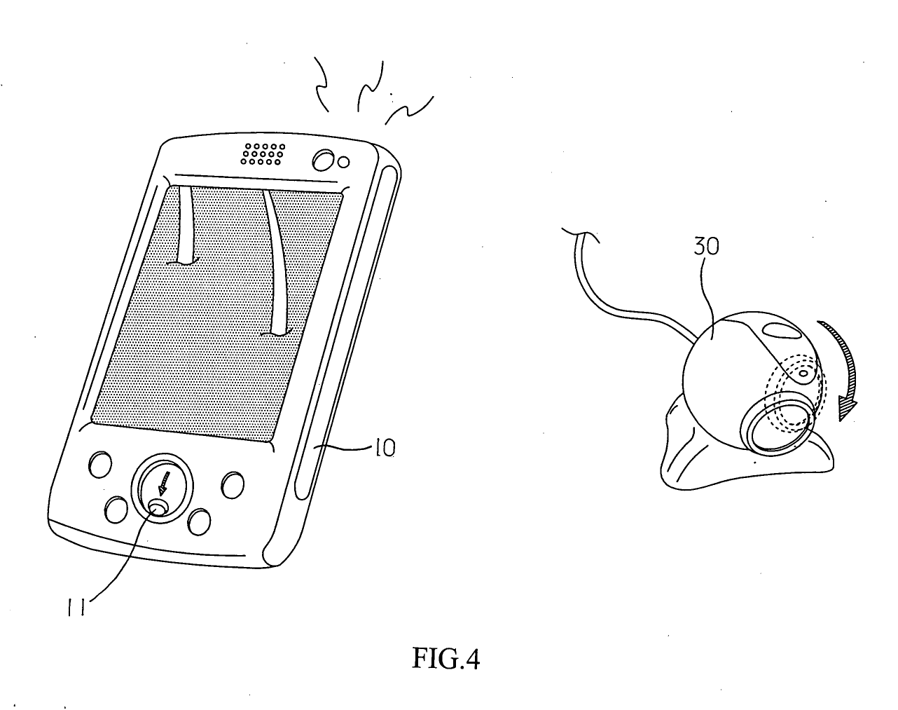

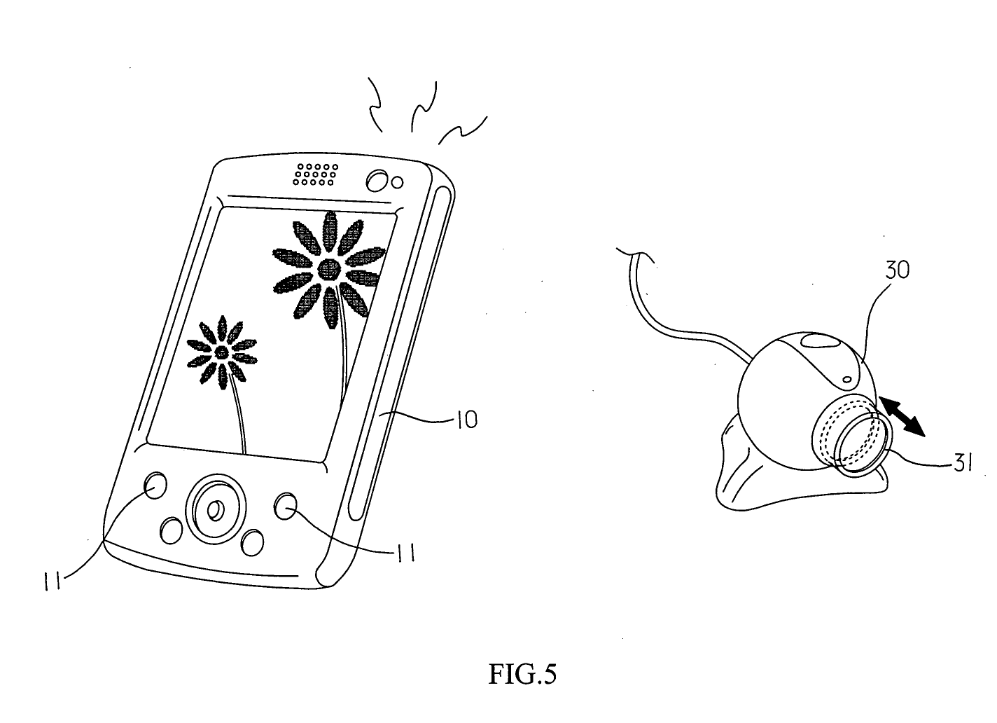

Further control command codes sent from the hand-held information equipment 10 is received by the control unit adapted to the video camera 30 to generate related control signals for driving the video camera 30 to rotate as illustrated in FIG. 3, adjust its elevation as illustrated in FIG. 4, or adjust its focus by digital or optical focusing as illustrated in FIG. 5. In the course of its operation of the video camera 30, pictures taken by a lens 31 of the video camera 30 is real time transmitted through the network protocol and the base station to the hand-held information equipment 10 for display so to allow its user to search for better pictures to shoot as desired.

The present invention effectively upgrades the real time monitor function at the same for hand-held information equipment and video camera by allowing a user to take advantage of its cellular phone, PDA or other similar hand-held information equipment to receive pictures from a remote video camera while controlling through the hand-held information equipment the video camera to search for shooting better pictures. Therefore, this application for a utility patent is duly filed accordingly. However, it is to be noted that that those preferred embodiments disclosed in the specification and the accompanying drawings are not limiting the present invention. Therefore, any construction, installation, or characteristics that is same or similar to that of the present invention should fall within the scope of the purposes and claims of the present invention

I claim,

1. An installation for fine tuning operation of a remote video camera includes a hand-held information equipment provided with functions of dynamic image display and wireless network transmission; a process software built in the hand-held information equipment to set up/judge command codes of operational keys; and one or multiple video camera adapted with a control unit for connection to the network for receiving operation signals transmitted from the hand-held information equipment.

2. The installation for fine-tuning operation of a remote video camera of claim 1, wherein, a key selected at random on the hand-held information equipment is set up to control the video camera to rotate.

3. The installation for fine-tuning operation of a remote video camera of claim 1, wherein, a key selected at random on the hand-held information equipment is set up to control the video camera to adjust its elevation.

4. The installation for fine-tuning operation of a remote video camera of claim 1, wherein, a key selected at random on the hand-held information equipment is set up to control the video camera to adjust its focus.

5. The installation for fine-tuning operation of a remote video camera of claim 4, wherein, the video camera varies its focus by digital focusing.

6. The installation for fine-tuning operation of a remote video camera of claim 4, wherein, the video camera varies its focus by optical focusing.

7. The installation for fine-tuning operation of a remote video camera of claim 4, wherein, the video camera varies its focus by digital and optical focusing.

8. The installation for fine-tuning operation of a remote video camera of claim 1, wherein, the process software further switches among pictures from multiple video cameras subject to the control by the hand-held information equipment.
